(19) United States
(12) Patent Application Publication
(10) Pub. No.: US 2008/0203871 A1
(43) Pub. Date: Aug. 28, 2008

(54) Door Insert Spacer

(76) Inventor: Michael Robinson, Winchester, VA (US)

Correspondence Address: KILPATRICK STOCKTON LLP, 1001 WEST FOURTH STREET, WINSTON-SALEM, NC, 27101, US

(21) Appl. No.: 12/037,605

(22) Filed: Feb. 26, 2008

Related U.S. Application Data
(60) Provisional application No. 60/903,843, filed on Feb. 28, 2007.

(51) Int. Cl. A47B 96/20; B32B 27/00

(52) U.S. Cl. 312/271; 156/60; 156/334

(57) ABSTRACT

A door is provided, comprising one or more frames with grooves, one or more insert panel spacers comprising a foamed adhesive, and one or more door insert panels. Also, a method for centering a door panel is provided, comprising the steps of applying a foamed hot melt adhesive to the groove of a door frame component and inserting the door panel into the groove. Further, a system for centering a door panel is provided, comprising a hot foam melt adhesive, an apparatus for applying the hot foam melt adhesive to the groove of a door frame component, and an apparatus for inserting the door panel into the groove. The foamed hot melt adhesive may be formulated by aerating the hot foam with a gas, which may be an inert gas, such as nitrogen. Benefits of the invention include centering a door insert panel and allowing room for the panel to expand and contract with changes in moisture content of the panel.

### CROSS-REFERENCE TO RELATED APPLICATION

This application claims priority to U.S. Provisional Application No. 60/903,863 for “DOOR INSERT SPACER” filed Feb. 28, 2007, the disclosure of which is herein incorporated by reference.

### FIELD OF THE INVENTION

The present invention relates generally to the field of door construction, and more particularly a means of centering the door insert panel and allowing room for the panel to expand and contract with changes in moisture content of the panel.

### BACKGROUND

Various methods have been used to locate and isolate the insert panel in doors, such as is used on kitchen cabinets, entrance doors, garage doors, furniture and the like. Methods such as soft wooden blocks, hollow tubing of various compositions, various molded shapes in the form of balls or spheres, all have been used as a means to locate and center the insert panel for many years. These various molded shapes, hollow tubes or other solid or semi-solid materials collectively are referred to as door insert spacers, or sometimes door insert bumpers. The insert panel may be of materials such as plywood, solid wood, or a veneer over a shaped or formed substrate, though materials such as glass and metal could also be used. There may also be more than one insert panel per door assembly. The insert panel is typically surrounded on four sides by a solid wood frame, though the frame can be of other materials. The insert panel is typically captured in a groove around the inside perimeter of the supporting frame, or in the case of multiple insert panels, also by grooves in additional vertical or horizontal door frame members.

In building a door of such construction, it is important to allow room for the center insert panel to expand or contract with changes in the environment. It is also necessary to secure the panel rigidly so as to prevent rattling of the panel when the door is used, and to prevent movement of the panel after the door is assembled. Yet another objective in manufacturing the door is to center the panel and prevent it from shifting.

Conventional methods have limitations due to either the materials that were available for use, or the design of such materials. If the material used to center and secure the insert panel was of molded construction, the size of the material was determined by the width of the perimeter groove in the door. Given that the width was of this dimension, the depth of the piece typically was the same dimension. This then determined the overall size of the insert panel, as the panel needed to make intimate contact with the material being used in order to support and center the insert panel. In many cases, the amount of room left for expansion, either due to the physical size of the material or the compressibility of it, did not allow room for the panel to expand and contract without either forcing the supporting frame apart or allowing the insert panel to become loose.

To control costs and for efficient application, other conventional designs have the door insert bumper placed at widely spaced intervals around the perimeter of the insert panel groove. This can be also necessary to provide the correct amount of resistance to panel expansion while still centering and securing the panel, but often leaves areas of the insert panel unsupported, which in turn allows the door insert panel to vibrate or rattle when the door is closed.

Therefore, it is desirable to provide a means to apply the door insert bumper in an automated fashion to accommodate high speed door production, while also retaining the capability to apply the door insert bumper in a hand-applied manner. Conventional methods and systems have a panel that could also fall out or move during final assembly of the door.

### SUMMARY

There is a present need to provide a more accommodating design for centering and securing a panel using a door insert spacer. This design is preferably capable of being automated, inexpensive, flexible in application, and compatible with the various types of materials used in door construction. To this end, the systems and processes described herein apply a “foamed” hot melt adhesive as a door insert spacer. The hot melt material is aerated with an inert gas, such as nitrogen, to provide the cushioning and supporting properties needed. The mixture of gas and hot melt adhesive can be varied proportionally to adjust the properties needed. This material is then injected into the receiving groove around the inside perimeter of the supporting door frame at whatever intervals are needed to provide support for the center insert panel. The amount of material can be adjusted to whatever amount is needed, in width, length, and depth, plus the frequency can be varied. The advantage of this invention is the material can be applied to accommodate the center insert panel size needed to adapt to environmental changes, rather than the previously available materials determining the insert panel size due to their design.

To achieve the stated and other features, advantages, and objectives, embodiments of the present invention include a process that can be easily automated, is very versatile in its application, and provides a more secure method of centering and securing the door insert panel.

It is also an advantage of the invention to allow for varying placement of the insert panel spacer material via a programmable interface. This would eliminate the need to change machine setups for the different lengths of door frame components.

An additional advantage of the invention is that it can easily accommodate door insert grooves that are of different depths, widths, or locations on the door inside perimeter. It could also be used in doors which have the insert panel captured in a rabbet in the door frame.

Another advantage is the material can be varied, both in density and placement, depending on the requirements of the environment the door is to be used in, and also the material the door and insert panel is manufactured from.

Another advantage is the material can also be placed by hand in door components that are difficult or impossible to run through an automated process.

An additional advantage is that the material is also adhesive, so it remains firmly in the door frame components during the door assembly process. Other types of insert spacers fit loosely in the door frame grooves and can fall out, which adds additional time to replace these items in the door assembly process.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The present invention will be more clearly understood from a reading of the following description in conjunction with the accompanying exemplary figures wherein:

FIG. 1 illustrates a typical door assembly, showing the door frame, insert panel, and insert panel spacers;

FIG. 2 is an illustration of a conventional insert panel spacer, which is a hollow tube;

FIG. 3 is an illustration of a conventional insert panel spacer, which is a molded rubber or foam shape;

FIG. 4 is a cross-sectional view of a typical door assembly; and

FIGS. 5A and 5B are enlargements of the cross-sectional view.

### DETAILED DESCRIPTION

Reference will now be made in detail to embodiments of the invention, one or more examples of which are illustrated in the accompanying attachments. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment of the invention can be used on another embodiment to yield a still further embodiment. Thus, it is intended that the present invention cover such modifications and variations that come within the scope of the invention.

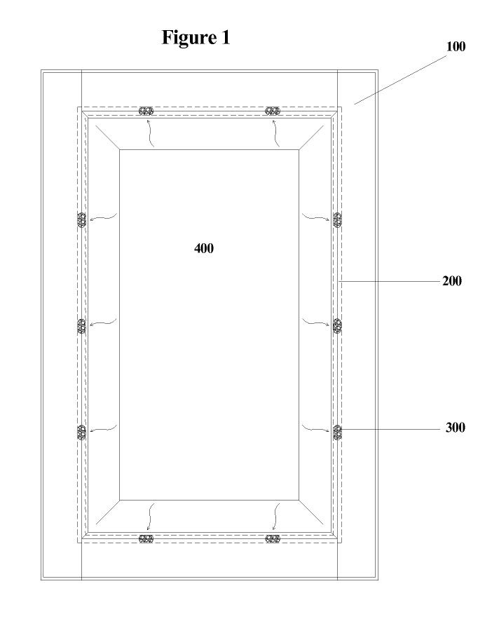

FIG. 1 is an illustration of a door assembly, being comprised of a center insert panel 400, a door frame 100 surrounding the center insert panel, and insert panel spacers 300 being used to center and secure the insert panel in the door frame. The insert panel spacers 300 may be placed in a groove 200 in the door frame 100. The number of insert panel spacers is simply an illustration of a possible combination of spacers, and can be varied in number, placement and size to accommodate any conceivable door size or configuration.

Because the door insert bumper is not normally visible after the door is assembled, there is very little perceived added value to the end consumer from an aesthetic perspective. This requires that the cost of the material be as inexpensive as possible as the cost cannot normally be passed on.

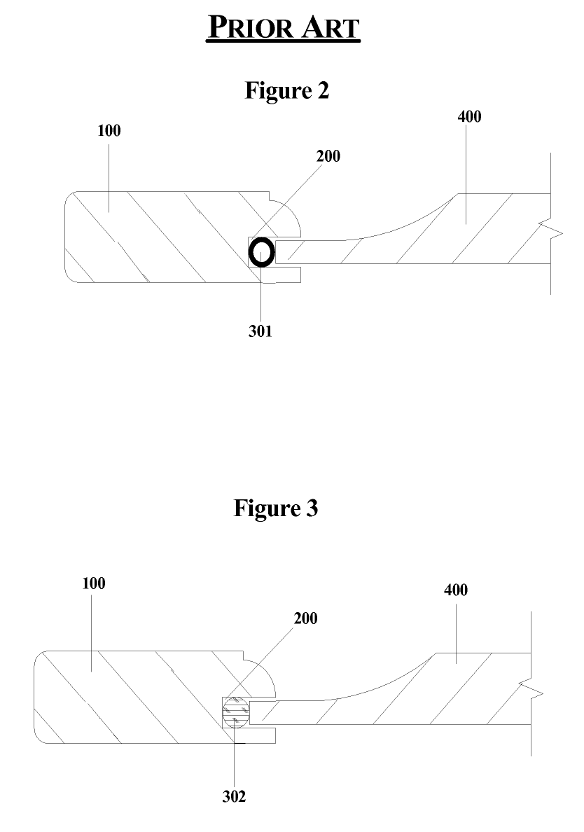

FIG. 2 is an illustration of a cross-sectional view of a door assembly, being comprised of a center insert panel 400, a door frame 100 surrounding the center insert panel, and an insert panel spacer 301 being used to center and secure the insert panel in the door frame. The insert panel spacer 301 may be placed in a groove 200 in the door frame 100.

The insert panel spacer 301 is a hollow tube that is formed from various compressible materials, such as silicone or PVC, and inserted in the groove in about one inch segments. Shaped solid foam insert spacers can act similarly to the silicone or PVC material. An inherent problem with this type of material is that, being round, the depth of the item is the same as the thickness. This dictates the dimensions of the insert panel and does not allow the controls needed to allow for a large range of insert panel swelling or shrinking due to changes in the environment. Conventional tube-shaped insert spacers are also prone to falling out during the door assembly process, which adds cost to the manufacturing process because the spacers must be manually replaced. Additionally, they can lead to quality issues if the missing spacer is not noticed during door assembly. Further, due to the design, the material offers limited compressibility. The open core of the tubing provides the only compressible area of this design. Cost for this type of material is also significantly more than that of the proposed invention, when comparing the amounts of each required to perform the same function. It is also difficult to automate the application of this into a typical door assembly, further adding costs.

FIG. 3 is an illustration of a cross-sectional view of a door assembly, being comprised of a center insert panel 400, a door frame 100 surrounding the center insert panel, and an insert panel spacer 302 being used to center and secure the insert panel in the door frame. The insert panel spacer 302 may be placed in a groove 200 in the door frame 100.

The insert panel spacer 302 illustrates another conventional insert spacer material, which is a molded material typically made of rubber or a foam material. These insert spacers are often shaped as a ball (“space ball”) or a “football” shape. Most of the problems with this type of insert spacer are the same as the hollow tubing described above. These problems include the shape dictating the panel size, and the spacers falling out during door assembly. They also offer limited compressibility due to the materials commonly used for them. Cost for this type of material is also significantly more than that of the proposed invention, when comparing the amounts of each required to perform the same function. It is also difficult to automate the application of this into a typical door assembly, further adding costs.

FIG. 4 is a cross-sectional view of a door assembly and illustrates an exemplary usage of the insert panel spacer 300. FIG. 4 illustrates a center insert panel 400, a door frame 100 surrounding the center insert panel, and an insert panel spacer 300 being used to center and secure the insert panel in the door frame. The insert panel spacer 300 may be placed in a groove 200 in the door frame 100.

FIG. 4 shows how the foamed material 300 fills the void between the insert panel 400 and the door frame 100, providing centering and securing of the panel. In a typical application of the material, the insert panel 400 would slightly compress the insert panel spacer 300, holding it securely and allowing for some shrinkage of the insert panel in a lower humidity environment. In this illustration you can see how the material could be injected to various thicknesses, allowing the insert panel 400 to be sized to dimensions that may be needed to accommodate the change in various materials due to changing environmental conditions.

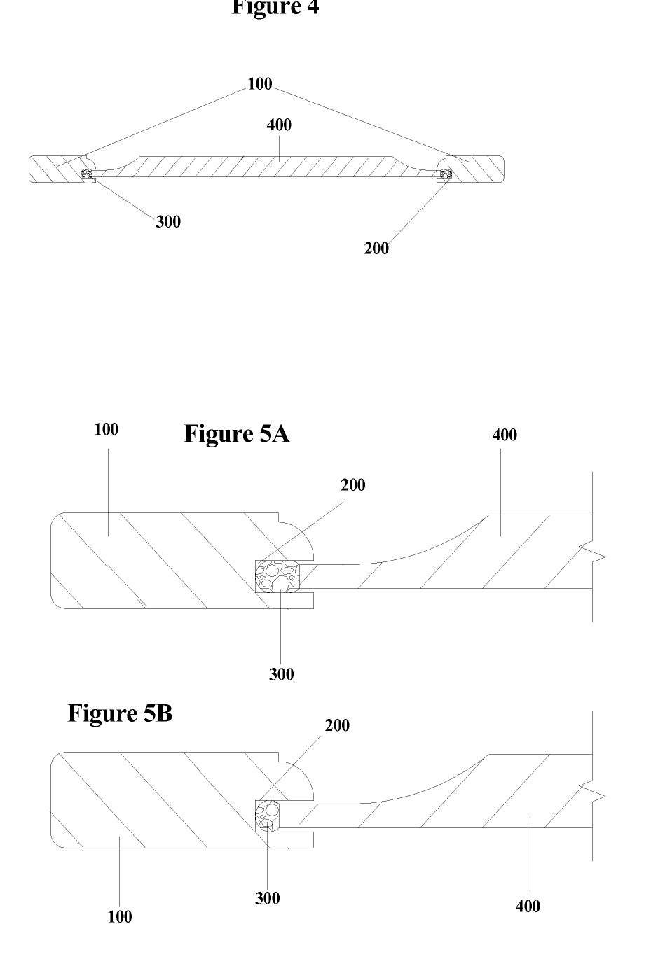

FIGS. 5A and 5B illustrate cross-sectional views of a door assembly and exemplary usages of the insert panel spacer 300. FIGS. 5A and 5B illustrate a center insert panel 400, a door frame 100 surrounding the center insert panel, and an insert panel spacer 300 being used to center and secure the insert panel in the door frame. The insert panel spacer 300 may be placed in a groove 200 in the door frame 100.

FIGS. 5A and 5B show two possible applications of the insert panel spacer material. First, FIGS. 5A and 5B show how the foamed material can be injected to varying depths to accommodate different insert panel expansion requirements. Second, FIGS. 5A and 5B illustrate how well the foamed material accommodates tolerances in insert panel dimensions.

FIG. 5A illustrates a large bead of material 300 that would be applied to allow for greater growth of an insert panel 400, such as one made from solid wood, which can grow significantly in a humid environment. The insert panel spacer material 300 simply compresses as the panel 400 grows, which prevents damage to the door frame 100 from the increased pressure from the insert panel 400. The insert panel spacer 300, being comprised of a flexible material containing gaseous bubbles, will also expand to near its original dimensions should the insert panel shrink at a later time.

FIG. 5B illustrates a smaller bead of material 300 that could be used for insert panels 400 that do not change significantly due to changes in the environment, such as plywood, metal, glass, veneer over a MDF or particle board substrate, etc.

Further embodiments (not pictured) may include a plurality of insert panels as well as a plurality of vertical and/or horizontal frame members. In such embodiments, the vertical and/or horizontal frame members may each contain grooves in which insert panel spacers and insert panels may be inserted in a manner similar to what is described above and in the figures.

In one exemplary embodiment, the insert panel spacer can be a bead of material approximately 0.5″ long and located approximately every 3″ around the periphery of the panel in the groove. The location of the insert panel spacer should accommodate joints and other pieces, such as cathedrals. It is recognized that the location and size of the insert panel spacer can vary depending on the type of wood and door configuration.

In one embodiment, the insert panel spacer comprises a material such as hot melt, such as those based on ethylene copolymers (e.g., EVA) produced by 3M. The hot melt can be aerated with an inert gas, such as nitrogen, using equipment such as is produced by Nordson. One exemplary product is described in U.S. Pat. No. 4,200,207 to Akers et al., which is incorporated by reference in its entirety.

The insert bumper spacer material can be applied to the door frame components prior to assembly of the door. In an exemplary process, an insert spacer can be positioned in the groove of a door frame component. This process can be automated using, for example, a programmed injection nozzle. The insert spacer dries within about two minutes once it cools down to room temperature (i.e., 20°-35° C.). After drying and solidification of the insert spacer, the panel can be inserted and the door can be assembled.

The embodiments described above are intended to be exemplary. One skilled in the art recognizes that numerous alternative components and embodiments that may be substituted for the particular examples described herein and still fall within the scope of the invention.

I claim:

1. A door comprising one or more insert panel spacers comprising a foamed adhesive material, positioned in one or more grooves of one or more door frames.

2. The door of claim 1, further comprising one or more door insert panels, wherein the one or more door insert panels are inserted into the one or more grooves and rest against one or more insert panel spacers joined to the one or more grooves.

3. The door of claim 1, wherein the foamed adhesive is formulated by aerating hot melt adhesive material with a gas.

4. The door of claim 3, wherein the gas is an inert gas.

5. The door of claim 3, wherein the gas is nitrogen.

6. The door of claim 3, wherein the hot melt adhesive material is based on an ethylene copolymer.

7. The door of claim 1, wherein the one or more insert panel spacers are approximately 0.5 inch in length

8. The door of claim 1, wherein the one or more insert panel spacers are positioned in the one or more grooves in the one or more frames at intervals of approximately 3 inches around the one or more frames.

9. The door of claim 8, wherein the one or more insert panel spacers are positioned in the one or more grooves in the one or more frames at intervals of approximately 3 inches around the one or more frames.

10. The door of claim 1, wherein the door is a cabinet door.

11. A method for centering one or more door insert panels into one or more frames, comprising:
applying a foamed hot melt adhesive to one or more grooves in the one or more frames; and
inserting the one or more door insert panels against the hot melt adhesive into the one or more grooves in the one or more frames.

12. The method of claim 11, further comprising:
formulating a foamed hot melt adhesive material by aerating hot melt adhesive material with a gas.

13. The method of claim 12, wherein the gas is an inert gas.

14. The method of claim 12, wherein the gas is nitrogen.

15. The method of claim 11, wherein the foamed hot melt adhesive is based on an ethylene copolymer.

16. The method of claim 11, wherein the foamed hot melt adhesive is applied to the one or more grooves in the one or more frames by hand.

17. The method of claim 11, wherein the foamed hot melt adhesive is applied to the one or more grooves in the one or more frames by a machine.

18. The method of claim 11, wherein the foamed hot melt adhesive is applied to the one or more grooves in the one or more frames by a programmed injection nozzle.

19. The method of claim 11, wherein approximately 0.5 inch of foamed hot melt adhesive is applied to the one or more grooves in the one or more frames at intervals of approximately 3 inches around the one or more frames.

20. The method of claim 11, further comprising:
allowing the foamed hot melt adhesive to dry before inserting the door insert panel.

21. The method of claim 11, further comprising:
allowing the foamed hot melt adhesive to reach room temperature before inserting the one or more door insert panels.

22. A system for centering a door insert panel into a frame, comprising:
an apparatus for applying a foamed hot melt adhesive to a groove in the frame; and
an apparatus for inserting the door insert panel against the hot melt adhesive into the groove in the frame.

23. The system of claim 22, wherein the apparatus for applying a foamed hot melt adhesive comprises a nozzle.

24. The system of claim 22, wherein the apparatus for applying a foamed hot melt adhesive comprises a programmed injection nozzle.

25. The system of claim 22, further comprising an apparatus for creating the foamed hot melt adhesive.

26. The system of claim 25, wherein the apparatus for creating the foamed hot melt adhesive comprises a machine that aerates the hot melt adhesive with an inert gas.

27. The system of claim 26, wherein the inert gas is nitrogen.

28. The system of claim 26, wherein the apparatus for creating the foamed hot melt adhesive is capable of varying the proportional mixture of gas and hot melt adhesive.

29. A door kit comprising:
one or more frames, each containing grooves;
foamed adhesive material; and
one or more door insert panels.

30. The door kit of claim 29, wherein the door kit is a cabinet door kit.
